(19) United States
(12) Patent Application Publication
(10) Pub. No.: US 2010/0022180 A1
(43) Pub. Date: Jan. 28, 2010

(54) VENTILATED WINDOW ARRANGEMENT

(75) Inventors: Kevin Barry Nutt, Summerfield, NC (US); Srikanth Sundaresh Ghantae, Greensboro, NC (US); Martin John Phillips, High Point, NC (US); Glyn Haugh, Greensboro, NC (US)

Correspondence Address: VOLVO TECHNOLOGY OF AMERICA, CORPORATE PATENTS, 7825 NATIONAL SERVICE ROAD, MAIL STOP, AP1/3-41, GREENSBORO, NC, 27409, US

(73) Assignee: Volvo Trucks North America, Inc., Greensboro, NC (US)

(21) Appl. No.: 12/448,718

(22) PCT Filed: Jan. 3, 2007
(86) PCT No.: PCT/US07/60034

§ 371 Date: Jul. 2, 2009

(51) Int. Cl. E06B 7/10

(52) U.S. Cl. 454/211

(57) ABSTRACT

A ventilated window arrangement includes a window and a window frame. The window frame includes an outer side and an inner side, an opening from the outer side to the inner side in which the window is mounted, and a ventilator passage extending from the outer side to the inner side. The ventilated window arrangement also includes a ventilator panel attached to the frame and movable from a closed position in which the ventilator panel seals the ventilator passage to an open position in which fluid communication between the outer side and the inner side is permitted.

### BACKGROUND AND SUMMARY

The present invention relates to a window and, more particularly, to a ventilated window arrangement.

In many instances it is desirable to provide ventilation to a space. Often this is accomplished by opening a window. However, in many modern buildings and motor vehicles, windows are provided but are not adapted to be opened and closed. For example, in a vehicle, a window may be permanently shut for security reasons, because the location of the window makes it impractical for the window to be opened or closed, or because the cost of providing a more complex openable and closeable window is prohibitive.

It is desirable to provide a ventilation arrangement for a window of the type that is not adapted to be opened and closed.

According to an aspect of the present invention, a ventilated window arrangement comprises a window and a one-piece window frame comprising an outer side and an inner side, an opening from the outer side to the inner side in which the window is mounted, and a ventilator passage extending from the outer side to the inner side. The ventilated window arrangement also comprises a ventilator panel attached to the frame and movable from a closed position in which the ventilator panel seals the ventilator passage to an open position in which fluid communication between the outer side and the inner side is permitted.

According to another aspect of the present invention, a ventilated window arrangement comprises a window and a window frame comprising an outer side and an inner side, an opening from the outer side to the inner side in which the window is mounted, and a ventilator passage extending from the outer side to the inner side. The ventilated window frame also comprises a one-piece ventilator panel comprising an integrally formed mounting portion, a hinge portion, and a panel portion, the mounting portion being attached to the frame, the hinge portion connecting the mounting portion and the panel portion and permitting movement of the panel portion between a closed position in which the panel portion seals the ventilator passage and an open position in which fluid communication between the outer side and the inner side is permitted.

According to another aspect of the present invention, a vehicle with a ventilated window arrangement is provided. The vehicle comprises a window opening. The vehicle also comprises a ventilated window arrangement comprising a window, and a window frame comprising an outer side and an inner side, an opening from the outer side to the inner side in which the window is mounted, a ventilator passage extending from the outer side to the inner side. The frame comprises a main body portion and a flange extending from the main body portion perpendicularly to a direction from the outer side to the inner side and extending around at least a substantial portion of the main body portion, the frame being attached in the window opening by the flange. The vehicle also comprises a ventilator panel attached to the frame and movable from a closed position in which the ventilator panel seals the ventilator passage to an open position in which fluid communication between the outer side and the inner side is permitted.

### BRIEF DESCRIPTION OF THE DRAWINGS

The invention is described in connection with a preferred embodiment shown in the following drawings in which:

FIG. 1 is a top, outside, perspective view of a ventilated window arrangement according to an embodiment of the present invention;

FIG. 2 is a top, inside, perspective view of a ventilated window arrangement according to an embodiment of the present invention;

FIG. 3 is a schematic, partially cross-sectional, side view of a portion of a vehicle with a ventilated window arrangement according to an embodiment of-the present invention; and

FIG. 4 is an exploded top, inside, perspective view of a ventilated window arrangement according to an embodiment of the present invention.

### DETAILED DESCRIPTION

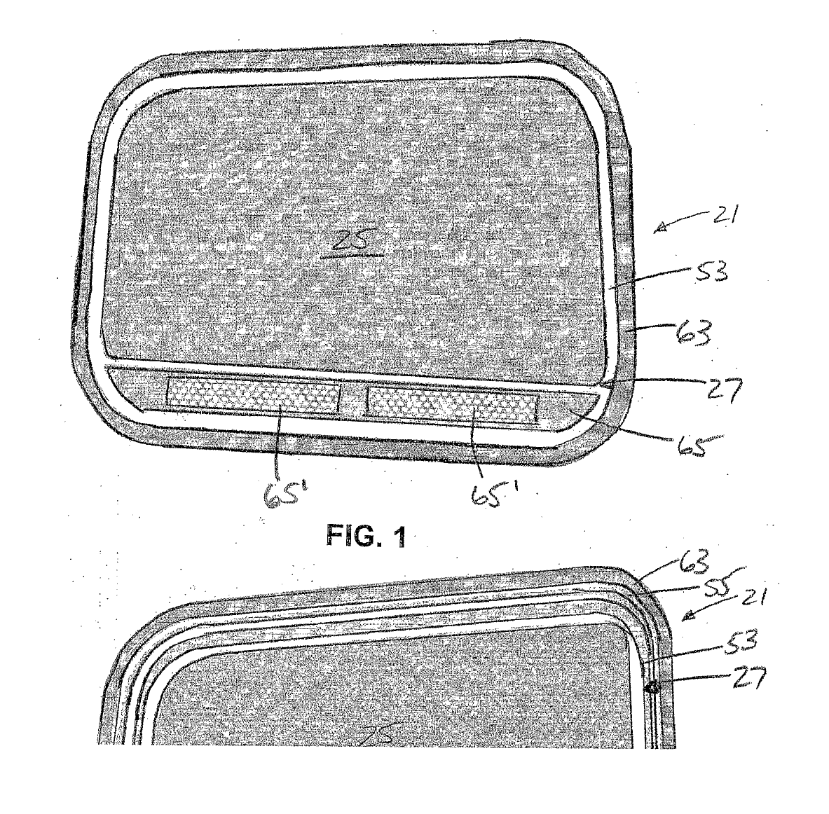

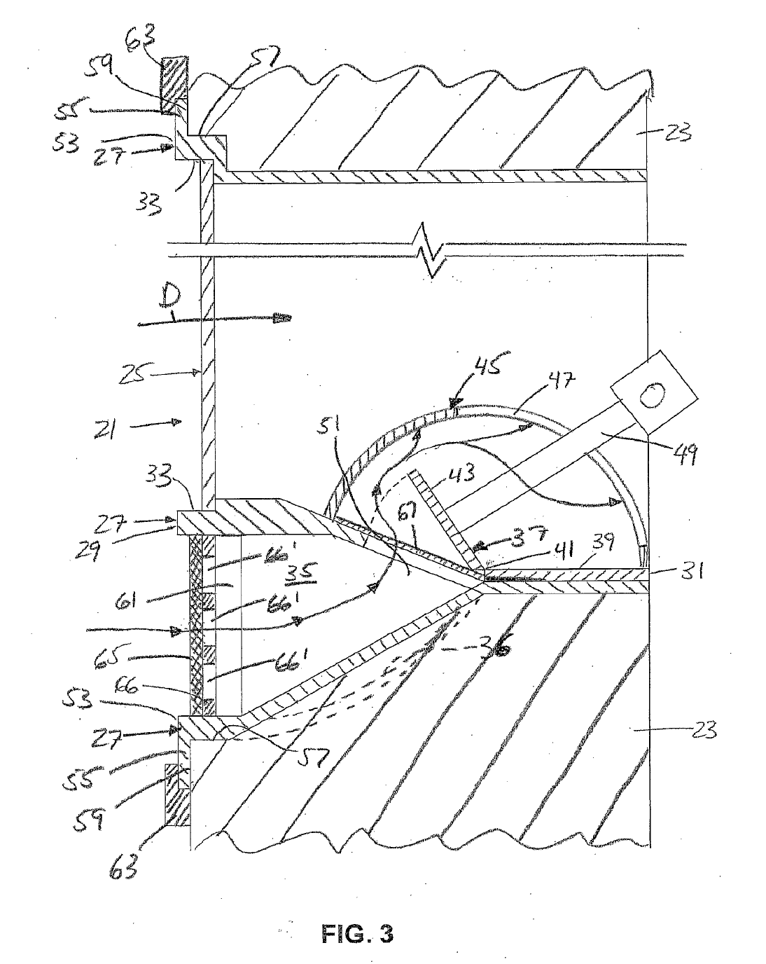

A ventilated window arrangement 21 according to an embodiment of the present invention is shown from an outer side in FIG. 1 and an inner side in FIG. 2. As seen in FIG. 3, the window arrangement 21 is mountable in a wall 23, such as the wall of a vehicle such as a truck. The window arrangement 21 is particularly useful in connection with applications in which it is desired to provide ventilation in connection with windows which must ordinarily remain closed, although the window arrangement may be used in connection with windows that are able to be opened and closed.

The window arrangement 21 comprises a window 25 and a window frame 27 comprising an outer side 29 and an inner side 31. An opening 33 extends through the window frame 27 from the outer side 29 to the inner side 31. The window 25 is mounted in the opening 33. A ventilator passage 35 extends from the outer side 29 to the inner side 31. The frame 27 can be formed as a one-piece article, such as by a suitable plastic molding procedure.

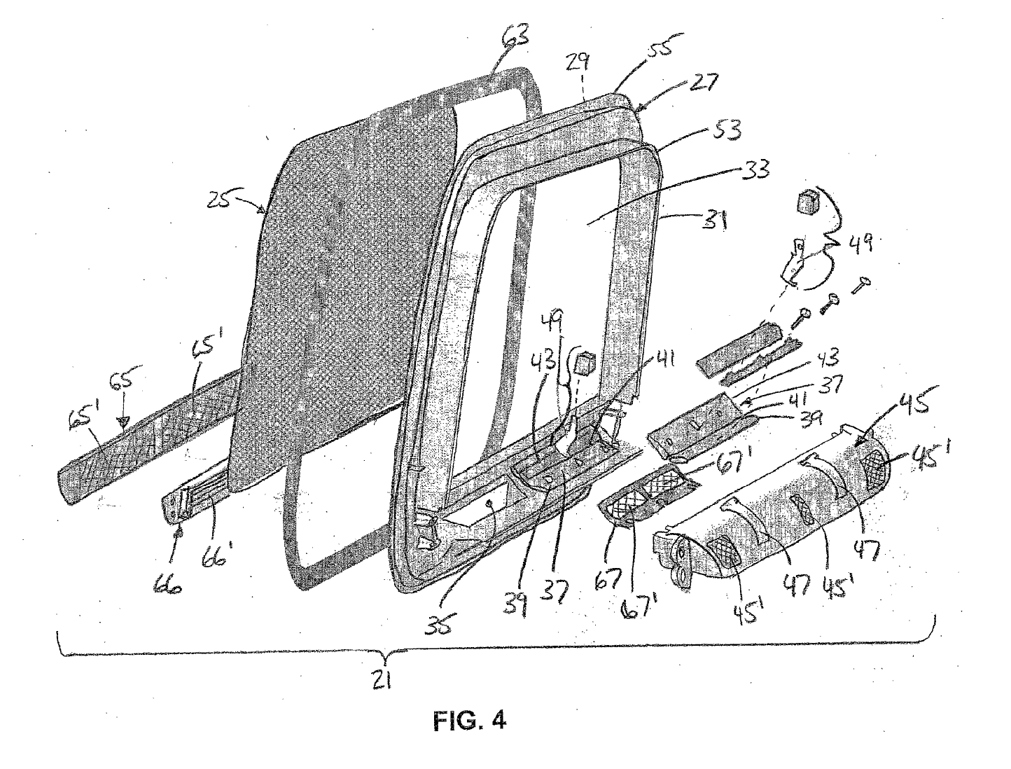

A ventilator panel 37 is attached to the frame 27 and is movable from a closed position in which the ventilator panel seals the ventilator passage 35 as shown in FIG. 4. to an open position in which fluid communication between the outer side 29 and the inner side 31 is permitted, as shown in phantom in FIG. 3. As seen in the exploded view of FIG. 4, the ventilator panel 37 comprises an integrally formed mounting portion 39, a hinge portion 41, and a panel portion 43. The mounting portion 39 is attached to the frame 27, the hinge portion 41 connects the mounting portion and the panel portion 43, and the panel portion is movable to open and close the ventilator passage. The mounting portion 39, the hinge portion 41, and the panel portion 43 can be formed as a single-piece, such as by a suitable plastic molding procedure. The hinge portion 41 can, for example, comprise portion that is thinner and more easily bent than the mounting portion 39 and the panel portion 43.

The window arrangement 21 can comprise a plurality of ventilator passages 35. A ventilator panel 37 can be associated with one or more ventilator passages 35 to open and close the ventilator passages, or a ventilator passage can be associated with one or more ventilator panels. Ordinarily, one ventilator panel 37 is associated with one ventilator passage 35. In the embodiment shown in FIGS. 2 and 4, a first ventilator passage 35 and a second ventilator passage 35 are disposed substantially adjacent to each other.

An inner ventilator grille 45 can be attached to the frame 27 over one or more ventilator passages 35. The inner ventilator grille 45 can comprise one more lever openings 47 and typically has one or more mesh-like openings 45′. A ventilator panel lever 49 can be attached to the each ventilator panel 37 and can extend through a lever opening 47 in the inner ventilator grille 45. In the embodiment shown in FIGS. 2 and 4, the panel portion 43 can be moved between the open and closed position relative to the inner end 51 of the passage 35 by sliding the ventilator panel lever 49 in the ventilator panel opening 47. In this embodiment, the ventilator panel lever 49 is movable in a lever opening in the form of a circular arc, however, it will be appreciated that the ventilator panel portion 43 might be moved by other forms of levers, such as levers (not shown) that are pulled or pushed relative to the inner ventilator grille 45 and that can be hingedly attached to the ventilator panel

The frame 27 can comprise a main body portion 53 and a flange 55 extending from the main body portion perpendicularly to a direction D from the outer side 29 to the inner side 31 and extending around at least a substantial portion of the main body portion. When the main body portion 53 is disposed in an appropriately sized opening 57 in the wall 23, the flange 55 can contact an outer (or inner) surface 59 of the wall and can be secured in that position by any suitable means, such as by adhesive or fasteners such as bolts or screws. To minimize the possibility of infiltration between the frame 27 and the wall 23, the flange 55 ordinarily extends around an entire periphery of the main body portion 53 to facilitate formation of a continuous seal. The flange 55 can be integrally molded with the main body portion 53. The window opening 33 and the ventilator passage 35 can extend through the main body portion 53. A gasket 63 may be applied around the flange 55.

As can be seen from FIGS. 3 and 4, an outer end 61 and an inner end 51 of the ventilator passage 35 define a non-zero angle with each other. As seen in FIG. 3, the inner end 61 of the ventilator passage 35 can be substantially parallel with the direction D from the outer side 29 to the inner side 31 of the frame 27, e.g., forming less than a 45° angle with the direction D. The outer end 61 of the ventilator passage 35 can be substantially perpendicular with the direction from the outer side 29 to the inner side 31 of the frame 27. The ventilator passage 35 can be curved, i.e., include a curved surface 36, as shown in phantom in FIG. 3.

An exterior grille 65 can cover the outer end 61 of the ventilator passage 35. The exterior grille 65 will typically have a plurality of mesh-like openings 65′. FIGS. 3 and 4 show a grille support 66 having a plurality of elongated openings 66′, wherein the grille 65 is mounted to the grille support which is, in turn, mounted to the frame 27 over the ventilator passage 35. The mounting portion 39 of the ventilator panel 37 can be mounted to the frame 27 proximate the inner end 51 of the ventilator passage. A screen 67 that typically includes a plurality of mesh-like openings 67′ (FIG. 4) can be mounted to the frame 27 over the inner end 51 of the ventilator passage 35, and the ventilator panel 37 can be mounted to the frame inwardly of the screen, e.g., with the screen between the mounting portion 39 of the ventilator panel and the frame. By providing the exterior grille 65 together with the panel portion 43 of the ventilator panel 37, ingress of water through the passage 35 can be minimized or prevented. In addition, by providing the inner end 51 of the passage 35 at a different angle than the outer end 61, ingress of water can be prevented or minimized. For example, by providing the inner end 51 facing upwardly and substantially parallel to a direction from the outer side 29 to the inner side 31, and by providing the outer end 61 substantially perpendicular to the inner end 51, the water will ordinarily be unable to traverse the upward curve or bend.

The vast majority of the components of the window arrangement 21 can be formed of plastic using conventional molding techniques, such as injection molding. For example, the frame 27, the ventilator panel 37, the inner ventilator grille 45, the exterior grille 65, the grille support 66, and the screen 67 can all be formed using injection molding techniques. In this way, the cost of producing the window arrangement 21 can be kept to a minimum, the potential for damage to the window from exposure to adverse weather conditions is minimal, and the parts can be light in weight.

In the present application, the use of terms such as “including” is open-ended and is intended to have the same meaning as terms such as “comprising” and not preclude the presence of other structure, material, or acts. Similarly, though the use of terms such as “can” or “may” is intended to be open-ended and to reflect that structure, material, or acts are not necessary, the failure to use such terms is not intended to reflect that structure, material, or acts are essential. To the extent that structure, material, or acts are presently considered to be essential, they are identified as such.

The invention must not be regarded as being limited to the exemplary embodiments described above, a number of further variants and modifications being feasible without departing from the scope of the following claims.

What is claimed is:

1. A ventilated window arrangement, comprising:
a window;
a one-piece window frame comprising an outer side and an inner side, an opening from the outer side to the inner side in which the window is mounted, and a ventilator passage extending from the outer side to the inner side; and
a ventilator panel attached to the frame and movable from a closed position in which the ventilator panel seals the ventilator passage to an open position in which fluid communication between the outer side and the inner side is permitted.

2. The ventilated window arrangement as set forth in claim 1, wherein the ventilator panel comprises an integrally formed mounting portion, a hinge portion, and a panel portion, the mounting portion being attached to the frame, the hinge portion connecting the mounting portion and the panel portion, and the panel portion being movable to open and close the ventilator passage.

3. The ventilated window arrangement as set forth in claim 1, wherein the ventilator passage comprises a first ventilator passage and a second ventilator passage, and the ventilator panel comprises a first ventilator panel and a second ventilator panel associated with the first ventilator passage and the second ventilator passage, respectively.

4. The ventilated window arrangement as set forth in claim 3, wherein the first ventilator passage and the second ventilator passage are disposed substantially adjacent to each other.

5. The ventilated window arrangement as set forth in claim 4, comprising an inner ventilator grille attached to the frame over the first and the second ventilator passages.

6. The ventilated window arrangement as set forth in claim 5, wherein the inner ventilator grille comprises first and second lever openings, first and second ventilator panel levers attached to the first and second ventilator panels extending through the first and second lever openings.

7. The ventilated window arrangement as set forth in claim 1, wherein the frame comprises a main body portion and a flange extending from the main body portion perpendicularly to a direction from the outer side to the inner side and extending around at least a substantial portion of the main body portion.

8. The ventilated window arrangement as set forth in claim 7, wherein the flange is integrally molded with the main body portion.

9. The ventilated window arrangement as set forth in claim 1, wherein an outer end and an inner end of the ventilator passage define a non-zero angle with each other.

10. The ventilated window arrangement as set forth in claim 9, wherein the inner end of the ventilator passage is substantially parallel with a direction from the outer side to the inner side.

11. The ventilated window arrangement as set forth in claim 10, wherein the outer end of the ventilator passage is substantially perpendicular with the direction from the outer side to the inner side.

12. The ventilated window arrangement as set forth in claim 9, wherein the ventilator passage is curved.

13. The ventilated window arrangement as set forth in claim 1, comprising an exterior grille covering an outer end of the ventilator passage, the ventilator panel being mounted to the frame proximate an inner end of the ventilator passage.

14. The ventilated window arrangement as set forth in claim 13, wherein an outer end and an inner end of the ventilator passage define a non-zero angle with each other.

15. The ventilated window arrangement as set forth in claim 13, comprising a screen mounted to the frame over the inner end of the ventilator passage, the ventilator panel being mounted to the frame inwardly of the screen.

16. A ventilated window arrangement, comprising:
a window;
a window frame comprising an outer side and an inner side, an opening from the outer side to the inner side in which the window is mounted, and a ventilator passage extending from the outer side to the inner side; and
a one-piece ventilator panel comprising an integrally formed mounting portion, a hinge portion, and a panel portion, the mounting portion being attached to the frame, the hinge portion connecting the mounting portion and the panel portion and permitting movement of the panel portion between a closed position in which the panel portion seals the ventilator passage and an open position in which fluid communication between the outer side and the inner side is permitted.

17. The ventilated window arrangement as set forth in claim 16, wherein the frame comprises a main body portion and a flange extending from the main body portion perpendicularly to a direction from the outer side to the inner side and extending around at least a substantial portion of the main body portion.

18. The ventilated window arrangement as set forth in claim 17, wherein the flange is integrally molded with the main body portion.

19. The ventilated window arrangement as set forth in claim 16, wherein an outer end and an inner end of the ventilator passage define a non-zero angle with each other.

20. A vehicle with a ventilated window arrangement, comprising:
a vehicle comprising a window opening;
a ventilated window arrangement comprising
a window,
a window frame comprising an outer side and an inner side, an opening from the outer side to the inner side in which the window is mounted, a ventilator passage extending from the outer side to the inner side, the frame comprising a main body portion and a flange extending from the main body portion perpendicularly to a direction from the outer side to the inner side and extending around at least a substantial portion of the main body portion, the frame being attached in the window opening by the flange, and
a ventilator panel attached to the frame and movable from a closed position in which the ventilator panel seals the ventilator passage to an open position in which fluid communication between the outer side and the inner side is permitted.
